(19) United States
(12) Patent Application Publication
(10) Pub. No.: US 2025/0290269 A1
(43) Pub. Date: Sep. 18, 2025

(54) Smart Real Estate Foundation Monitoring System

(71) Applicant: Chalmette Ray, Pearland, TX (US)

(72) Inventor: Chalmette Ray, Pearland, TX (US)

(21) Appl. No.: 18/974,455

(22) Filed: Dec. 9, 2024

Related U.S. Application Data
(63) Continuation-in-part of application No. 18/107,725, filed on Feb. 9, 2023, now abandoned.

(51) Int. Cl. E02D 33/00; G06Q 50/16

(52) U.S. Cl. CPC E02D 33/00; G06Q 50/16; E02D 2600/10

(57) ABSTRACT

A smart real estate foundation monitoring system is disclosed. The system is configured to provide real-time visibility into the health and integrity of a real estate's foundation. The system utilizes a network of sensors, strategically located within a real estate, to continuously measure the physical stresses exerted on the real estate frame to detect wall deflections, structural cracks, and foundation movements. The smart real estate foundation monitoring system serves as a valuable early warning system which can detect problems before they arise. The system integrates with a real estate's existing Wi-Fi to securely stream sensor data to a cloud server where it is further processed and analyzed to generate alerts, dashboards, and reports.

This continuation-in part application claims priority to U.S. application Ser. No. 18/107,725, titled “SMART REAL ESTATE FOUNDATION MONITORING SYSTEM”, filed Feb. 9, 2023, the entirety of which is incorporated here by reference.

### BACKGROUND

The present disclosure relates, in general, to residential and commercial building network monitoring systems, and more particularly, but without limitation, to residential and commercial foundation monitoring through a smart real estate network.

Structural monitoring systems are known in the art.

U.S. Pat. No. 9,458,593 discloses a deep pile foundation construction methodology for existing and new buildings.

U.S. Pat. No. 10,087,596 discloses a method and apparatus for keeping foundations flat.

US 2022/0167130 discloses an apparatus and method to detect foundation movement.

Currently, a real estate owner/property owner, such as residential real estate owner or a commercial real estate owner may need to be aware of various structural issues associated with the real estate, such as foundation issues, structural issues, subsidence, corrosion, structure fatigue, wood rot and other internal issues that may not be apparent to a real estate owner. The real estate owner may have to hire an independent inspector to investigate these unseen issues, leaving the real estate owner to trust the inspector without separate, unbiased confirmation.

Therefore, a need exists for a practical, convenient and affordable monitoring system for foundations of real estate, using rin-building real estate network systems such as smart real estate networks.

### SUMMARY

A smart real estate foundation monitoring system is disclosed. The system is configured to provide real-time visibility into the health and integrity of a real estate's foundation. The system utilizes a network of sensors, strategically located within a real estate, to continuously measure the physical stresses exerted on the real estate frame to detect wall deflections, structural cracks, and foundation movements. The smart real estate foundation monitoring system serves as a valuable early warning system which can detect problems before they arise. The system integrates with a real estate's existing Wi-Fi to securely stream sensor data to a cloud server where it is further processed and analyzed to generate alerts, dashboards, and reports

In an aspect, a system to monitor a foundation of a real estate in a smart real estate network is disclosed. The system includes at least one memory configured to store computer executable instructions; and at least one processor configured to execute the computer executable instructions to: retrieve real estate environmental conditions from one or more sensors in communication with the smart real estate network and configured to monitor conditions affecting the foundation of the real estate; retrieve regional environmental conditions from an external network source; determine a foundation risk factor based on the real estate environmental conditions and/or the regional environmental conditions; and provide a risk factor alert to a user of the smart real estate network

In an aspect, a method to monitor a foundation of a real estate in a smart real estate network is disclosed. The method includes retrieving real estate environmental conditions from one or more sensors in communication with the smart real estate network and configured to monitor conditions affecting the foundation of the real estate; retrieving regional environmental conditions from an external network source; determining a foundation risk factor based on the real estate environmental conditions and/or the regional environmental conditions; and providing a risk factor alert to a user of the smart real estate network.

In an aspect, a computer program product to monitor a foundation of a real estate in a smart real estate network is disclosed. The computer program product includes a non-transitory computer readable medium having stored thereon computer executable instructions, which when executed by one or more processors, cause the one or more processors to monitor a foundation of a real estate in a smart real estate network, the operations comprising: retrieving real estate environmental conditions from one or more sensors in communication with the smart real estate network and configured to monitor conditions affecting the foundation of the real estate; retrieving regional environmental conditions from an external network source; determining a foundation risk factor based on the real estate environmental conditions and/or the regional environmental conditions; and providing a risk factor alert to a user of the smart real estate network.

The foregoing summary is illustrative only and is not intended to be in any way limiting. In addition to the illustrative aspects, aspects, and features described above, further aspects, aspects, and features will become apparent by reference to the drawings and the following detailed description

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows components of one aspect of a computing environment for monitoring a foundation of a real estate in a smart real estate network, according to an aspect of the disclosure;

FIG. 2 shows one aspect of a client computer for monitoring a foundation of a real estate in a smart real estate network, according to an aspect of the disclosure;

FIG. 3 shows one aspect of a network computer that may at least partially implement one of the various aspects for monitoring a foundation of a real estate in a smart real estate network, according to an aspect of the disclosure;

FIG. 4 illustrates an exemplary diagram of a network for monitoring a foundation of a real estate in a smart real estate network, according to an aspect of the disclosure;

FIG. 5 illustrates a flowchart for acts taken in an exemplary method for monitoring a foundation of a real estate in a smart real estate network, according to an aspect of the disclosure;

FIG. 6a illustrates an example foundation of a property, according to an aspect of the disclosure; and

FIG. 6b illustrates an example graphic display of a foundation risk factor, according to an aspect of the disclosure.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well known features have not been described so as not to obscure the disclosure. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

A smart real estate foundation monitoring system is disclosed herein. In an aspect of the disclosure, the system is configured to provide real-time visibility into the health and integrity of a real estate's foundation. For the purposes of this present disclosure but without limitation, “real estate” means residential real estate housing, whether multi-family or single family home residences, and commercial real estate buildings, interchangeably where not so identified.

In an aspect of the disclosure, the system utilizes a network of one or more sensors configure to monitor conditions affecting the foundation of the real estate, strategically located within a real estate, and in communication with a smart real estate network, to continuously measure the physical stresses exerted on the real estate frame to detect wall deflections, structural cracks, and foundation movements. In an aspect, the smart real estate foundation monitoring system serves as a valuable early warning system which can detect problems before they arise. In a further aspect, the system integrates with a real estate's existing Wi-Fi or other communications network to securely stream sensor data to an external data source, such as a cloud-based external network server where it is further processed, including additional processing regional environmental conditions and analyzed to generate alerts, dashboards, and/or reports for a user of the smart real estate network foundation monitoring system.

The disclosed smart real estate foundation monitoring system will be further illustrated with the detailed description of the following exemplary and non-limiting figures and aspects of the present disclosure.

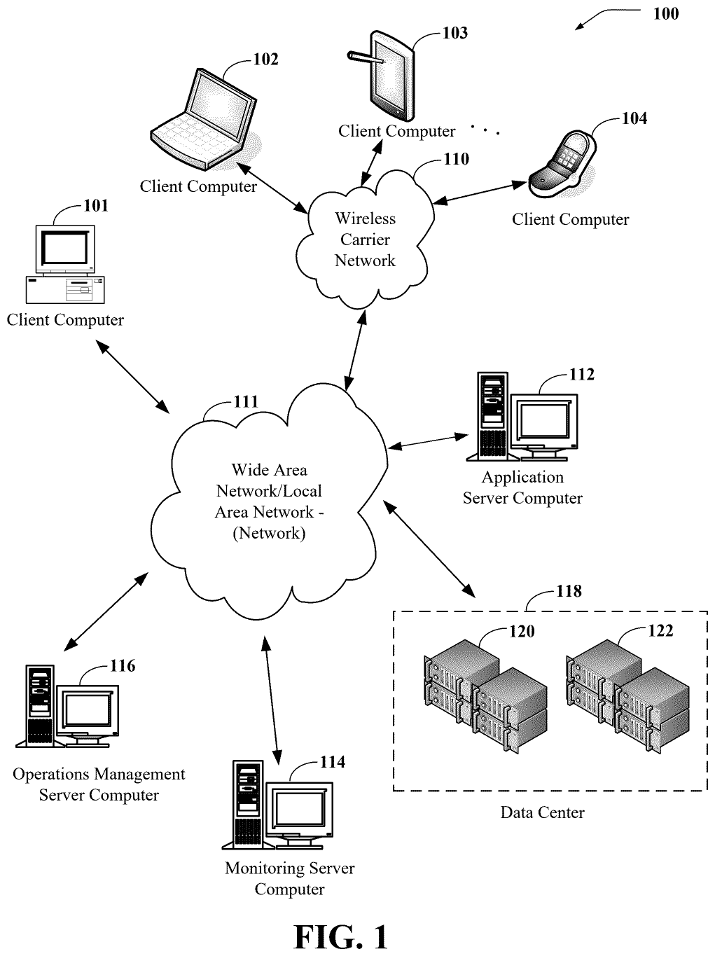

FIG. 1 shows components of one aspect of a computing environment 100 to monitor a foundation of a real estate in a smart real estate network. Not all the components may be required to practice various aspects, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement the disclosed medical technology B2B marketplace.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one aspect, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one aspect, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other aspects. Further, it should be recognized that more or less client computers may be included within a system such as described herein, and aspects are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one aspect, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. In essence, the network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

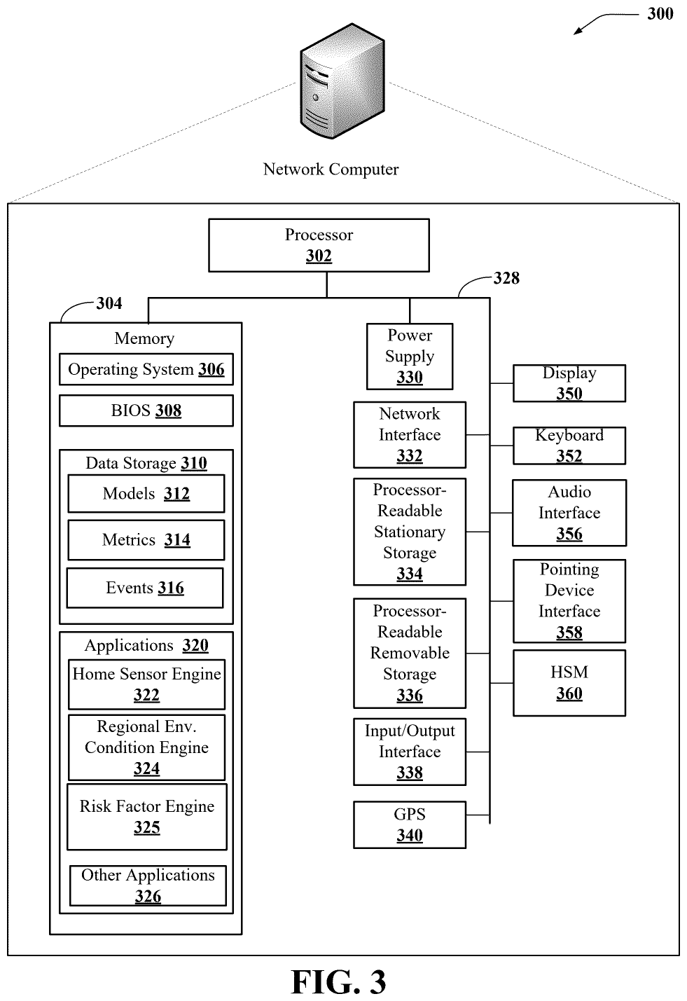

The operations management server computer 116 may include virtually any network computer usable to provide computer operations management services, such as a network computer, as described with respect to FIG. 3. In one aspect, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various aspects, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some aspects, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the disclosure is not so limited. Thus, the operations management server computer 116 may represent a plurality of network computers. For example, in one aspect, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some aspects, one or more data centers, such as a data center 118, may be communicatively coupled to the wireless network 110 and/or the network 111. In at least one of the various aspects, the data center 118 may be a portion of a private data center, public data center, public cloud environment, or private cloud environment. In some aspects, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some aspects, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various aspects, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

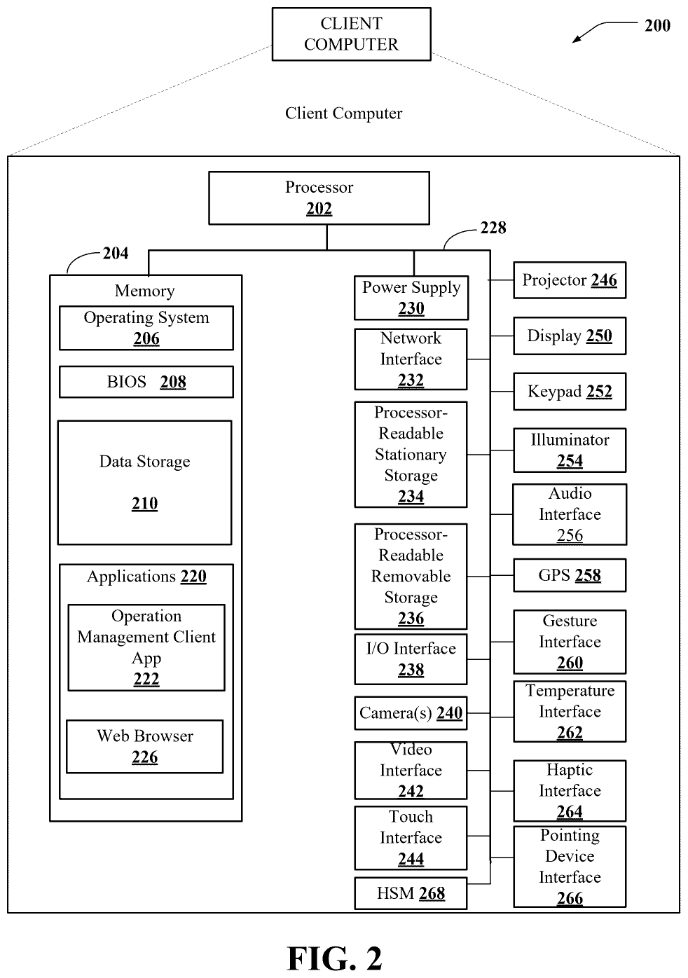

FIG. 2 shows one aspect of a client computer 200. The client computer 200 may include more or less components than those shown in FIG. 2. The client computer 200 may represent, for example, at least one aspect of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one aspect, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

In an aspect, the I/O interface may also include one or more sensors in communication with a smart real estate network, such as a temperature sensor, a rain sensor, a humidity sensor, a strain sensor, a temperature sensor, a wind sensor, a barometer, a carbon monoxide sensor, a radon sensor, a seismometer, a hygrometer, fiber optic sensors, accelerometer sensors, electromagnetic sensors (EMF sensors), electromechanical sensor, load cells, inclinometer, acoustic emission sensors, microphones, wire coil-encased sensors, olfactory and odor sensors, gas and flame chromatography sensors, etc. Other examples of sensors that may be used with the disclosed system include, but are not limited to, sensors embedded in structural concrete to measure relative humidity data and temperature to provide data on concrete foundation strength and maturity; air temperature, relative humidity, and light; Infrared (IR) dual beam break sensors for measuring human occupancy; proximity IR sensors for human activity/proximity near surfaces; surface temperatures; water activity of surfaces; CO₂ and an automated injection and decay system for air exchange measurements; differential pressure; ultrasonic sensors, infrasonic sensors and other real estate structural sensors known to one of skill in the art. In an aspect, different sensors may be used in different applications for the real estate, such as a subset of the disclosed sensors above may be applicable to residential housing, some may be applicable to residential buildings, such as sensors embedded in foundation walls and surfaces, while other sensors may be applicable to both residential and commercial real estate structures, as known to one of skill in the art.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one aspect, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one aspect, at least some of the data storage 210 might also be stored on another component of the client computer 200, including, but not limited to, the non-transitory processor-readable removable storage device 236, the processor-readable stationary storage device 234, or external to the client computer or any other computer-readable storage device within the network computer 200 or external to network computer 200. The data storage 210 may include, for example, models 212, operations metrics 214, events 216, or the like. Other data records included in the data storage 210 may include computer code instructions and/or algorithms for executing a trained machine learning model that is capable of assisting the secure voting system and application to recommend certain candidates or propositions up on a current ballot. In an aspect, the trained machine learning model may include an artificial intelligence model, a Bayesian inference model or other machine or statistical learning model.

The applications 220 may include computer executable instructions which, when executed by the client computer 200, transmit, receive, or otherwise process instructions and data. The applications 220 may include, for example, an operations management client application 222. In at least one of the various aspects, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more aspects (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the client computer 200 may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one aspect of network computer 300 that may at least partially implement one of the various aspects. The network computer 300 may include more or fewer components than those shown in FIG. 3. The network computer 300 may represent, for example, one aspect of at least one medical technology B2B marketplace system according to the disclosure, such as the operations management server computer 116 of FIG. 1, the monitoring server computer 114 of FIG. 1, or an application server computer 112 of FIG. 1. Further, in some aspects, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one aspect, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one aspect, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may include a real estate sensor engine 322, a regional environmental condition engine 324, a risk factor engine 325, or other applications 326. In at least one of the various aspects, one or more of the applications may be implemented as modules or components of another application. Further, in at least one of the various aspects, applications may be implemented as operating system extensions, modules, plugins, or the like.

In an aspect, the real estate sensor engine 322 may retrieve real estate environmental conditions from one or more sensors in communication with the smart real estate network and configured to monitor conditions affecting the foundation of the real estate. In an aspect, the one or more sensors in communication with the smart real estate network comprise a temperature sensor, a rain sensor, a humidity sensor, a strain sensor, a temperature sensor, a wind sensor, a barometer, a carbon monoxide sensor, a radon sensor, etc. Other examples of sensors that may be used with the disclosed system include, but are not limited to, sensors embedded in structural concrete to measure relative humidity data and temperature to provide data on concrete foundation strength and maturity; air temperature, relative humidity, and light; Infrared (IR) dual beam break sensors for measuring human occupancy; proximity IR sensors for human activity/proximity near surfaces; surface temperatures; water activity of surfaces; CO2 and an automated injection and decay system for air exchange measurements; differential pressure; ultrasonic sensors, infrasonic sensors and other real estate structural sensors known to one of skill in the art.

In an aspect, the regional environmental condition engine 324 may retrieve regional environmental conditions from an external network source. In an aspect, the regional environmental condition engine 324 may retrieve the regional environmental conditions from a cloud-based network in communication with the smart real estate network. In a further aspect, the regional environmental condition engine 324 may retrieve precipitation data, seismic data, temperature data, ground subsidence data, historical climatological data, vermin infestation data, geothermal data, vulcanological data, radiological data, environmental gas diffusion data, flood plain data, etc.

In an aspect, the risk factor engine 325 may determine a foundation risk factor based on the real estate environmental conditions and/or the regional environmental conditions, and in an aspect, may provide a risk factor alert to a user of the smart real estate network. In an aspect, the risk factor engine 325 may determine at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure, etc. In an aspect, the risk factor engine 325 may provide a risk factor alert by transmitting an alert to the user, display a graphic dashboard of the foundation risk factor, provide advisory information for mitigating the foundation risk factor, etc. The risk factor engine 325 may then use a trained machine learning model, such as an artificial intelligence model to determine a foundation risk factor based on the real estate environmental conditions and/or the regional environmental conditions, and in an aspect, may provide a risk factor alert to a user of the smart real estate network. In an aspect, the risk factor engine 325 may train the trained machine learning model with supervised learning based on historical foundation model data, historical regional environmental conditions and professional engineering guidance regarding the historical foundation model data and the historical regional environmental conditions. In an aspect, the risk factor engine 325 may determine the foundation risk factor based on the real estate environmental conditions and/or the regional environmental conditions including at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure or a combination thereof. In an aspect, the trained machine learning model may include, but is not limited to, neural networks, deep learning, linear regression, decision trees, random forest, and XGBoost. Any or all of these machine learning models may serve as or be incorporated into an artificial intelligence model or algorithm.

Furthermore, in at least one of the various aspects, the real estate sensor engine 322, the regional environmental condition engine 324, the risk factor engine 325, or other applications 326, or the like, may be operative in a cloud-based computing environment. In at least one of the various aspects, these applications, and others, that comprise the management platform may be executing within virtual machines or virtual servers that may be managed in a cloud-based based computing environment. In at least one of the various aspects, in this context the applications may flow from one physical network computer within the cloud-based environment to another depending on performance and scaling considerations automatically managed by the cloud computing environment. Likewise, in at least one of the various aspects, virtual machines or virtual servers dedicated to the real estate sensor engine 322, the regional environmental condition engine 324, the risk factor engine 325, or other applications 326, may be provisioned and de-commissioned automatically.

In at least one of the various aspects, the applications may be arranged to employ geo-location information to select one or more localization features, such as, time zones, languages, currencies, calendar formatting, or the like. Localization features may be used in user-interfaces and well as internal processes or databases. Further, in some aspects, localization features may include information regarding culturally significant events or customs which may provide a source of audio compositions for evaluation (e.g., concerts, performances, local holidays, political events, or the like). In at least one of the various aspects, geo-location information used for selecting localization information may be provided by the GPS transceiver 340. Also, in some aspects, geolocation information may include information providing using one or more geolocation protocol over the networks, such as, the wireless network 108 or the network 111.

Also, in at least one of the various aspects, the real estate sensor engine 322, the regional environmental condition engine 324, the risk factor engine 325, and/or other applications 326, or the like, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 360 may be a stand-alone network computer, in other cases, the HSM 360 may be arranged as a hardware card that may be installed in a network computer.

Additionally, in one or more aspects (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the network computer may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

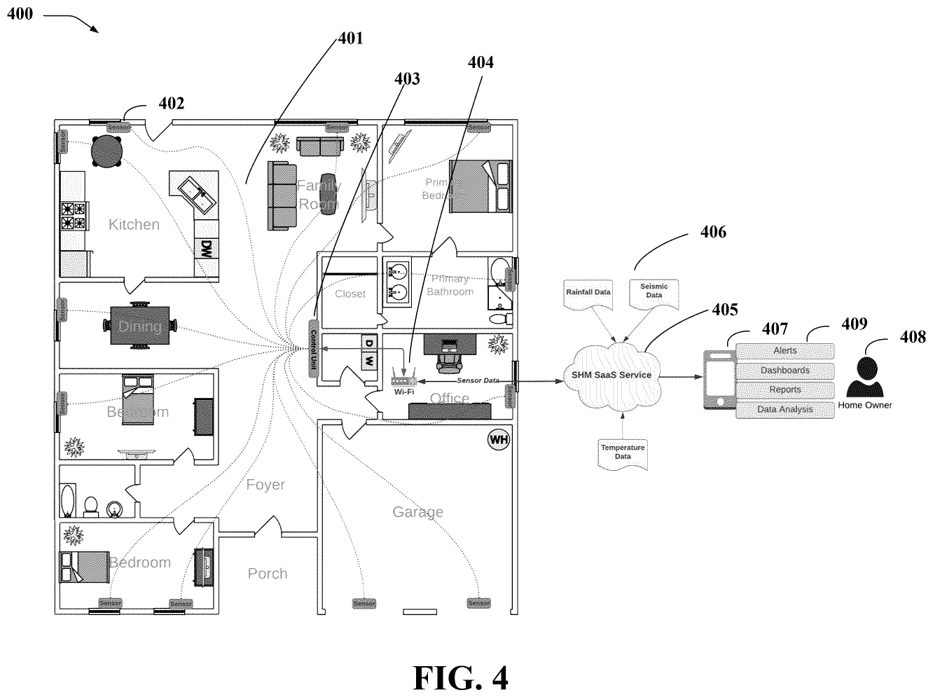

FIG. 4 illustrates an exemplary diagram of a network 400 for monitoring a foundation of a real estate, whether residential real estate or commercial real estate, in a smart real estate network 401. The smart real estate network 401 may be a wired or wireless data communication network. Examples of the smart real estate network 401 include, but not are not limited to, wired interfaces such as Ethernet or telephone wired networks, wireless interface networks such as WiFi (802.11xx), Bluetooth®, ZigBee, IrDA, cellular telecommunications networks (3GPP, CDMA, 4G LTE, 5G, 6G, etc.), WiMAX, satellite communications networks and other wired and wireless data communications networks known to one of skill in the art to enable the smart real estate network 401. In an aspect, the smart real estate network 401 may include connected devices, such as smart televisions, cellular phones and smartphones, computers (desktop, laptop, servers, terminals, etc.), wearable devices and smart watches, tablets, real estate entertainment and access devices such as voice-activated interface devices, audiovisual equipment, Internet-of-Things (IoT) devices, satellite dishes, network hubs, routers, extenders, network appliances and other devices interfaced to and interoperable with the smart real estate network 401. In particular, in an aspect, the smart real estate network includes one or more sensors 402 in communication with the smart real estate network and configured to monitor conditions affecting the foundation of the real estate. The one or more sensors 402 (illustrated throughout FIG. 4 as “Sensor”) may be placed and located in various locations around the real estate, such as, but without limitation, a kitchen, a bedroom, a living room, a bedroom, a library, a garage, a bathroom, an office, a dining room, a family room, a basement, an attic, a crawlspace or other rooms or additions to a real estate where one or more sensors 402 may be positioned or located and in communication with the smart real estate network 401. In a particular aspect, the one or more sensors 402 are placed in physical, mechanical, electromagnetic or other communication with a structure of a foundation of the real estate where the smart real estate network 401 is located. Examples of the one or more sensors 401 for monitoring the foundation of the real estate with a smart real estate network 401 include, but are not limited to, such as a temperature sensor, a rain sensor, a humidity sensor, a strain sensor, a temperature sensor, a wind sensor, a barometer, a carbon monoxide sensor, a radon sensor, etc. Other examples of sensors that may be used with the disclosed system include, but are not limited to, sensors embedded in structural concrete to measure relative humidity data and temperature to provide data on concrete foundation strength and maturity; pipe leak sensors (under and within the structure leaks can result in tremendous damage. It could be an internal pin leak that can cause a sagging wall which can then cause a sagging in the flooring. Excessive or above average amounts of water mixing in the soil components will lead to cracks and sloping in a foundation if not detected very every early on); irrigation system leak sensors (sprinkler systems located on site or nearby can have leaks at times which can introduce an abnormal amount of water reaching the subject structure); tree root and vegetation root obstruction (root systems stemming from established and ageing trees including vegetation with large crowns can enter pipes interrupt water flow in pipes under the structure thereby causing back flow and can cause a shift in the foundation of a structure due to a sewer like environment. The roots can also compete with a foundation structure for water; leak detection due to pools or large bodies of water (Lakes or Oceans or Bayous or Ponds)—Structures close in proximity to these bodies of water will be influenced by possible abnormal water influx due to the detection of leaks or an overload of water introduced into the system located at the structure. Many times, the cause comes from a pool resurfacing done incorrectly, rust that causes holes in the basin or the pipes; air conditioner sensors (detect the hot spots in the units located at the structure. Leaks can cause unnecessary moisture and water build up and puddling too close to the structure. Also provide consistent temperature output in rooms consistent with the thermostat assigned to the space); air temperature, relative humidity, and light; Infrared (IR) dual beam break sensors for measuring human occupancy; proximity IR sensors for human activity/proximity near surfaces; surface temperatures; water activity of surfaces; CO2 and an automated injection and decay system for air exchange measurements; differential pressure; ultrasonic sensors, infrasonic sensors and other real estate structural sensors known to one of skill in the art.

In an aspect, the one or more sensors 402 may be embedded or disposed within structures, such as walls, beams within walls, foundation walls, pipes, wiring conduits, phone line conduits, data communications line conduits, etc. In an aspect, the one or more sensors 402 may be embedded or disposed within wire coils or other surroundings or encasements.

In an aspect, the smart real estate network 401 may include a central control unit 403 of the smart real estate network 401 in communication with the one or more sensors 402 in communication with the smart real estate network 401. The central control unit 403 may be a network hub, a desktop or server computer, laptop, router, dedicated network appliance or a component of a computer or computing device with processors to execute operations and instructions to communicate with and coordinate and receive information from the one or more sensors 402 in the smart real estate network 401.

In an aspect, the smart real estate network 401 may include a WiFi router 404 in communication with the smart real estate network 401, the one or more sensors 402 and/or the central control unit 403. In an aspect, the WiFi router 404 may be substituted with a different wired or wireless interface router operating under a different interface protocol, such as wired interfaces such as Ethernet or telephone wired networks; wireless interface networks such as WiFi (802.11xx), Bluetooth®, ZigBee, IrDA, cellular telecommunications networks (3GPP, CDMA, 4G LTE, 5G, 6G, etc.), WiMAX, satellite communications networks; and other wired and wireless data communications networks known to one of skill in the art to enable the smart real estate network 401.

The WiFi router 404 (or other suitable wired/wireless router device) is, in an aspect, in communication with an external cloud-based network source 405. The external cloud-based network source 405 may be a cloud storage server or server farm, a cloud computing service, a distributed database, a web server or other network storage and/or computing resource. The external cloud-based network source 405 may execute cloud-based software applications such as SaaS applications, including, but not limited to a Smart Real estate Monitoring (SHM) SaaS service. The WiFi router 404 transmits real estate environmental conditions from one or more sensors 402 in communication with the smart real estate network 401 and configured to monitor conditions affecting the foundation of the real estate to the external cloud-based network source 405.

In an aspect, the external cloud-based network source 405 may retrieve or receive regional environmental conditions data 406. In an aspect, regional environmental conditions data 406 may include precipitation data, seismic data, temperature data, ground subsidence data, historical climatological data, vermin infestation data, geothermal data, vulcanological data, radiological data, environmental gas diffusion data, flood plain data, etc.

In an aspect, the external cloud-based network source 405 may process the real estate environmental conditions from one or more sensors 402 in communication with the smart real estate network 401 and configured to monitor conditions affecting the foundation of the real estate and/or the regional environmental conditions data 406 to determine a foundation risk factor based on the real estate environmental conditions and/or the regional environmental conditions. In an aspect, the external cloud-based network source 405 may determine a real estate foundation risk factor that may include at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure or the like. The external cloud-based network source 405 may determine the real estate foundation risk factor by weighting certain elements of the real estate environmental conditions and the regional environmental conditions according to known risk contributions to foundation integrity and stability, based on mechanical, structural and physical laws and standards, building code standards and/or regional environmental trends or risks (such as earthquake, volcanos, geothermal stresses, flooding, extreme heat or extreme cold, radiological risks such as radon or radioactive isotopes present in the soil near the real estate, CO and CO2 diffusion through the soil, subsistence of ground conditions, flood plain data, groundwater levels, porosity of the soil and foundation materials and other foundation structural factors known to one of skill in the art to evaluate).

In an aspect, the external cloud-based network source 405 may communicate with a user equipment (UE) 407 to provide the real estate foundation risk factor information. The UE 407 may provide a risk factor alert to a user 408 of the smart real estate network 401. In an aspect, the risk factor alert may be presented as a graphical, audiovisual, tactile or other alert presentation 409.

In an aspect, the system may transmit an alert to the user 408, display a graphic dashboard of the foundation risk factor, provide advisory information for mitigating the foundation risk factor, or the like. In an aspect, the risk factor alert may be an audible, visual, audiovisual, haptic (vibrational), augmented reality or other transmitted alert signal. In an aspect, the risk factor alert may be displayed in a color-coded diagram or map showing levels of foundation risk, such as green, yellow, red, in order of increasing risk, for example. In another aspect, the risk factor alert may be transmitted as a text message, SMS, email message, web page served to the user 408 or other verbal or audio-visual transmission of the risk factor alert. Other presentations of the risk factor alert may be contemplated by one of skill in the art.

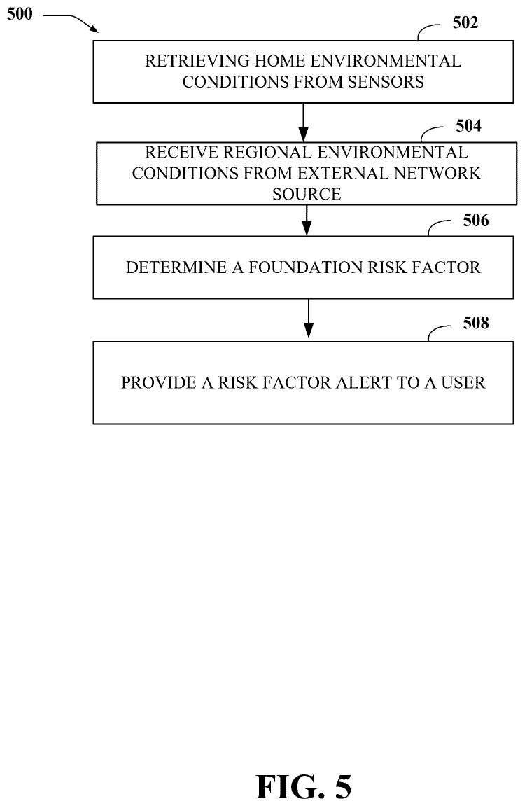

FIG. 5 illustrates a flowchart 500 for acts taken in an exemplary method for monitoring a foundation of a real estate in a smart real estate network. FIG. 5 is explained in conjunction with FIG. 1 to FIG. 4. The control starts at act 502.

At act 502, the system retrieves real estate environmental conditions from one or more sensors in communication with the smart real estate network and configured to monitor conditions affecting the foundation of the real estate. In an aspect, the one or more sensors in communication with the smart real estate network comprise a temperature sensor, a rain sensor, a humidity sensor, a strain sensor, a temperature sensor, a wind sensor, a barometer, a carbon monoxide sensor, a radon sensor, etc.

At act 504, the system retrieves regional environmental conditions from an external network source. In an aspect, the system may retrieve the regional environmental conditions from a cloud-based network in communication with the smart real estate network. In an aspect, the cloud-based network may be a cloud storage server or server farm, a cloud computing service, a distributed database, a web server or other network storage and/or computing resource.

In an aspect, the system may retrieve regional environmental conditions such as precipitation data, seismic data, temperature data, ground subsidence data, historical climatological data, vermin infestation data, geothermal data, radiological data, environmental gas diffusion data, vulcanological data, flood plain data, etc.

At act 506, the system determines,, using a trained machine learning model, a foundation risk factor based on the real estate environmental conditions and/or the regional environmental conditions. In an aspect, the system may determine at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure. Other foundation risk factors may be included as known to one of skill in the art.

In an aspect, the system may train the machine learning model with supervised learning based on historical foundation model data, historical regional environmental conditions and professional engineering guidance regarding the historical foundation model data and the historical regional environmental conditions. In an aspect, training the machine learning model may involve analyzing raw data collected from the various sensor to be analyzed by licensed and certified structural engineers, geological sciences engineers and/or other engineers or scientists with experience in evaluating risk factors that may be important to calculating the foundation risk factors. These professionals may be selected from members of The National Society of Professional Engineers and International Residential Code and even down to more specialized groups like The American Society of Civil Engineers or other professionally licensed bodies of building science and engineering professionals.

In an aspect, along with other professionals discussed above such as geological engineers, etc., consulting with and working with professionals certified in this area of expertise like that observed in Soil Science of America will allow for testing to see what grade of soil or soils exist at and around a structure site. Whether a new structure built or an existing structure having specific intel about the soil at a given structure site may provide insight about the soil stability, the soil strength, the soil chemistry and other properties. This information when paired with the other data in the sensor network affords an owner to have a more stable and safe structure with a longer structure life.

At act 508, the system may provide a risk factor alert to a user of the smart real estate network. In an aspect, the system may transmit an alert to the user, display a graphic dashboard of the foundation risk factor, provide advisory information for mitigating the foundation risk factor. In an aspect, the risk factor alert may be an audible, visual, audiovisual, haptic (vibrational), augmented reality or other transmitted alert signal. In an aspect, the risk factor alert may be displayed in a color-coded diagram or map showing levels of foundation risk, such as green, yellow, red, in order of increasing risk, for example. In an aspect, the foundation risk factor may be quantified in monetary amounts of damage or repairs at risk, a time to failure of foundation structural elements, or other qualitative or quantitative risk measures to inform a user of foundation risk. In another aspect, the risk factor alert may be transmitted as a text message, SMS, email message, web page served to the user or other verbal or audio-visual transmission of the risk factor alert. Other presentations of the risk factor alert may be contemplated by one of skill in the art.

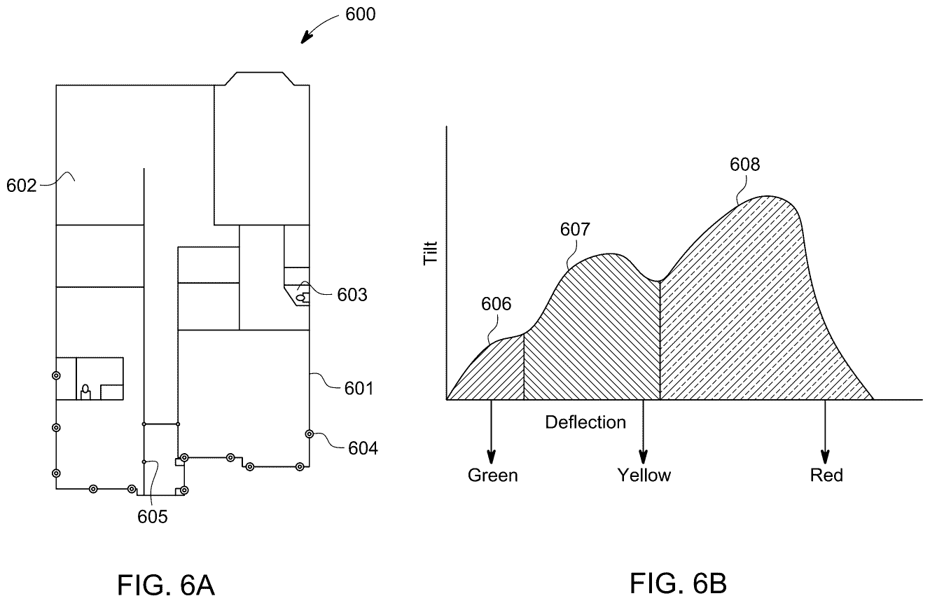

FIG. 6a illustrates an example blueprint of a foundation 600 of a building of interest, according to an aspect of the disclosure. In an aspect, the foundation 600 may include a number of standard structural elements that make up a building foundation. Such structural elements may include walls 601, interior rooms 602, interior doors 603, exterior pilings 604, interior pilings 605 and other structural elements that may be present in a foundation 600 that may be of interest to be monitored for tilt, deflection, warpage, environmental and other conditions disclosed herein. Sensors may be placed in communication with any or all of the structural elements illustrated in FIG. 6a to monitor tilt, deflection, stress, strain, temperature, humidity, gas seepage, vermin infestation or other measurements of interest in calculating a foundation risk factor. In an exemplary aspect of the disclosure, as illustrated in FIG. 6b, a foundation risk factor may be displayed as a color-coded graph of areas of a foundation 600 with calculated foundation risk factors based on tilt and deflection of an area (such as room of the foundation 600 or the entire foundation 66) or a structural element of the foundation 600. In an aspect, tilt of the foundation 600 may be measured by tilt meters or sensors. In an aspect, deflection may be calculated from the basic formula for calculating building foundation deflection, which is essentially the amount a foundation bends under load, given by: δ=(5*w*L\hat{ }4)/(384*E*I), where δ is the deflection, w is the distributed load per unit length, L is the span length, E is the modulus of elasticity of the concrete, and I is the moment of inertia of the foundation slab. Foundation movement may be calculated by measuring the tilt and deflection of the foundation 600 as shown above, to be used in calculating the foundation risk factor.

In FIG. 6b, a graph of tilt vs. deflection as shown may have different amounts of foundation risk factor value that can be displayed as a color-coded graph. In a first region 606, the tilt and deflection measures may be considered acceptable for a given building based on age, location, geological and climatological factors among other environmental conditions, types of materials, used, etc. The first region 606 may be color-coded “green” for example, to indicate “good” or “acceptable. Likewise, a second region 607 may illustrate larger tilt vs. deflection values, indicating a marginally worse foundation risk factor than that indicated by the first region 606. This second region 607 may be color-coded “yellow” indicating “attention needed” or “higher risk”. As described herein, risk may be quantified as dollar amounts to repair, time to failure, value of property at risk or other qualitative or quantitative measurements of risk of interest and value to a user of the disclosed application.

A third region 608 may reflect even higher tilt vs. deflection values for foundation movement, warranting heightened attention by a user. This third region 608 may be color-coded “red” to indicate “high alert”, “imminent failure” or other serious alert to warn a user of the potential or impending damage, failure or collapse of the foundation and its consequent cost or risk to building dwellers. Other color-coding, shading, or presentation may be used to communicate the foundation risk factor to a user. In an aspect, other graphs or dashboards of graphs may be displayed including other aspect of the foundation risk factor, such as climatological, seismic, radiation, noxious gas or chemical seepage, rot, vermin infestation, tree root impingement, water table movement and flooding risk, or other risk factors that may be displayed instead of or in addition to foundation movement as a component of the foundation risk factor.

Blocks of the flowchart 500 support combinations of means for performing the specified functions and combinations of operations for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system to monitor a foundation of a real estate in a smart real estate network, the system comprising:
at least one memory configured to store computer executable instructions; and at least one processor configured to execute the computer executable instructions to:
retrieve real estate environmental conditions from one or more sensors in communication with the smart real estate network and configured to monitor conditions affecting the foundation of the real estate;
retrieve regional environmental conditions from an external network source;
determine, using a trained machine learning model, a foundation risk factor based on the real estate environmental conditions and/or the regional environmental conditions; and
provide a risk factor alert to a user of the smart real estate network.

2. The system of claim 1, where the one or more sensors in communication with the smart real estate network comprise a temperature sensor, a rain sensor, a humidity sensor, a strain sensor, a temperature sensor, a wind sensor, a barometer, a carbon monoxide sensor, a radon sensor or a combination thereof.

3. The system of claim 1, where the computer executable instructions to retrieve the regional environmental conditions from an external network source comprise computer executable instructions to retrieve the regional environmental conditions from a cloud-based network in communication with the smart real estate network.

4. The system of claim 1, where the computer executable instructions to retrieve the regional environmental conditions from an external network source comprise computer executable instructions to retrieve precipitation data, seismic data, temperature data, ground subsidence data, historical climatological data, vermin infestation data, geothermal data, vulcanological data, radiological data, environmental gas diffusion data, flood plain data or a combination thereof.

5. The system of claim 1, where the computer executable instructions to determine, by the trained machine learning model, the foundation risk factor based on the real estate environmental conditions and/or the regional environmental conditions comprise computer executable instructions to determine at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure.

6. The system of claim 1, where the computer executable instructions to provide the risk factor alert to the user of the smart real estate network comprise computer executable instructions to transmit an alert to the user, display a graphic dashboard of the foundation risk factor, provide advisory information for mitigating the foundation risk factor or a combination thereof.

7. The system of claim 1, further comprising a central control unit of the smart real estate network in communication with the one or more sensors in communication with the smart real estate network.

8. The system of claim 1, further comprising computer executable instructions to train the trained machine learning model with supervised learning based on historical foundation model data, historical regional environmental conditions and professional engineering guidance regarding the historical foundation model data and the historical regional environmental conditions.

9. A computer-implemented method to monitor a foundation of a real estate in a smart real estate network, the method comprising:
retrieving real estate environmental conditions from one or more sensors in communication with the smart real estate network and configured to monitor conditions affecting the foundation of the real estate;
retrieving regional environmental conditions from an external network source;
determining, by a trained machine learning model, a foundation risk factor based on the real estate environmental conditions and/or the regional environmental conditions; and
providing a risk factor alert to a user of the smart real estate network.

10. The method of claim 9, where the one or more sensors in communication with the smart real estate network comprise a temperature sensor, a rain sensor, a humidity sensor, a strain sensor, a temperature sensor, a wind sensor, a barometer, a carbon monoxide sensor, a radon sensor or a combination thereof.

11. The method of claim 9, where retrieving the regional environmental conditions from an external network source comprises retrieving the regional environmental conditions from a cloud-based network in communication with the smart real estate network.

12. The method of claim 9, where retrieving the regional environmental conditions from an external network source comprise retrieving precipitation data, seismic data, temperature data, ground subsidence data, historical climatological data, vermin infestation data, geothermal data, radiological data, environmental gas diffusion data, vulcanological data, flood plain data or a combination thereof.

13. The method of claim 9, where determining, by the trained machine learning model, the foundation risk factor based on the real estate environmental conditions and/or the regional environmental conditions comprise determining, by the trained machine learning model, at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure.

14. The method of claim 9, where providing the risk factor alert to the user of the smart real estate network comprises transmitting an alert to the user, display a graphic dashboard of the foundation risk factor, provide advisory information for mitigating the foundation risk factor or a combination thereof.

15. The method of claim 9, further comprising training the trained machine learning model with supervised learning based on historical foundation model data, historical regional environmental conditions and professional engineering guidance regarding the historical foundation model data and the historical regional environmental conditions.

16. A computer program product comprising a non-transitory computer readable medium having stored thereon computer executable instructions, which when executed by one or more processors, cause the one or more processors to monitor a foundation of a real estate in a smart real estate network, the operations comprising:
retrieving real estate environmental conditions from one or more sensors in communication with the smart real estate network and configured to monitor conditions affecting the foundation of the real estate;
retrieving regional environmental conditions from an external network source;
determining, by a trained machine learning model, a foundation risk factor based on the real estate environmental conditions and/or the regional environmental conditions; and
providing a risk factor alert to a user of the smart real estate network.

17. The computer program product of claim 15, where the one or more sensors in communication with the smart real estate network comprise a temperature sensor, a rain sensor, a humidity sensor, a strain sensor, a temperature sensor, a wind sensor, a barometer, a carbon monoxide sensor, a radon sensor or a combination thereof.

18. The computer program product of claim 15, where the operations for retrieving the regional environmental conditions from an external network source comprise operations for retrieving the regional environmental conditions from a cloud-based network in communication with the smart real estate network.

19. The computer program product of claim 15, where the operations for retrieving the regional environmental conditions from an external network source comprise operations for retrieving precipitation data, seismic data, temperature data, ground subsidence data, historical climatological data, vermin infestation data, geothermal data, radiological data, environmental gas diffusion data, vulcanological data, flood plain data or a combination thereof.

20. The computer program product of claim 15, where the operations for determining, by the trained machine learning model, the foundation risk factor based on the real estate environmental conditions and/or the regional environmental conditions comprise operations for determining, by the trained machine learning model, at least one of a foundation stress/strain measure, a foundation subsidence measure, a foundation leak measure, a foundation fracture measure, a foundation rot measure, an environmental gas leakage measure, a radon leakage measure, a vermin infestation measure or a foundation heat loss measure.
